(19) United States
(12) Patent Application Publication
(10) Pub. No.: US 2012/0089447 A1
(43) Pub. Date: Apr. 12, 2012

(54) Method and System for Promoting Products and Projects

(76) Inventor: Brad Martin Listermann, Palm Springs, CA (US)

(21) Appl. No.: 13/269,584

(22) Filed: Oct. 8, 2011

Related U.S. Application Data
(60) Provisional application No. 61/391,587, filed on Oct. 9, 2010.

(51) Int. Cl. G06Q 30/02

(52) U.S. Cl. 705/14.16

(57) ABSTRACT

A computer-implemented system and method comprise obtaining from a potential user a favorite selection of viewed presentations. User registration information is obtained from the potential user. Registration confirmation that the potential user has been accepted as a registered user and the registered user is entered into a contest is received. A message inviting potential users to view a presentation, become a registered user and participate in the contest, at least one contact name and an address for the contact name is obtained from the registered user. The message is sent to the contact name at the address. Status information at least indicating contacts accepting the invitation, points awarded in the contest for the acceptances and prizes available in exchange for points is received. A selection of at least one prize to be redeemed with the registered user's points is received from the registered user.

### CROSS-REFERENCE TO RELATED APPLICATIONS

The present Utility patent application claims priority benefit of the U.S. provisional application for patent Ser. No. 61391587 entitled “COMPUTERIZED SYSTEM AND METHOD OF REWARDING FANS OF VARIOUS MEDIA”, filed on 9 OCT. 2010 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to computer systems. More particularly, the invention relates to systems for marketing/promoting products and projects.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Social networks, websites and other services often depend on third party entities to market and/or promote their products.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example GUI presentation for subscribing with the system or accessing the system, in accordance with an embodiment of the present invention;

FIG. 2 illustrates an example GUI presentation for communicating with contacts, in accordance with an embodiment of the present invention;

FIG. 3 illustrates an example GUI presentation for presenting results and prizes, in accordance with an embodiment of the present invention;

FIG. 4 illustrates a block diagram depicting a conventional client/server communication system;

FIG. 5 illustrates an example method for operation of system for interacting with users and for processing, in accordance with an embodiment of the present invention; and

FIG. 6 illustrates a typical computer system that, when appropriately configured or designed, may serve as a computer system for which the present invention may be embodied.

### Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention will be described which provide means and methods for a system for rewarding users for marketing and/or promoting projects and/or products. System rewards fans with shares of stock as allowed by security laws and regulations, points, prizes and contests in exchange for promotion of the item.

System uses multi-level marketing software for tracking persons subscribing as users and for tracking user's associated contacts and contacts of contacts provided to the system.

System enables a user with the capability to encourage another person to become a user of the system.

Users are provided the capability for encouraging contacts to become users of the system. As a result of successfully encouraging contacts to subscribe to the system, users are reward with stock in a company as allowed by security laws and regulations, points, merchandise and contests. Furthermore, users may view information related to contacts subscribed, number of contacts subscribed, contacts of contacts subscribed, number of contacts of contacts subscribed, number of shares of stock earned, number of points earned and available awards/prizes/contests.

System may also process information associated with users. As a non-limiting example, system may process received information for generating promotions and promotional materials.

A fan of a project or product may select and place a favorite selection for viewing by other persons. Other persons may view the favorite selection and also select the project or product as a favorite. Furthermore, following favorite selection, other persons may subscribe as a user of the system. Furthermore, following subscription, user is entered into contest and is prompted to encourage other persons to subscribe to the system as a user. Users, via the system, may encourage others to subscribe as a user. Non-limiting examples for encouraging others include viral videos, email templates and integrated social networking interfaces.

System receives and stores information associated with users, users' contacts and contacts of contacts. Received information is stored in a database and processed by the system.

System provides the capability for users to encourage contacts to subscribe to system. Non-limiting examples of capabilities for encouraging contacts to subscribe include software, website, applications, tools, widgets and mobile applications.

System provides utilities and applications to support blogging efforts of users for encouraging others to become subscribers of the system.

System provides means and methods for enabling a social network associated with marketing products and projects.

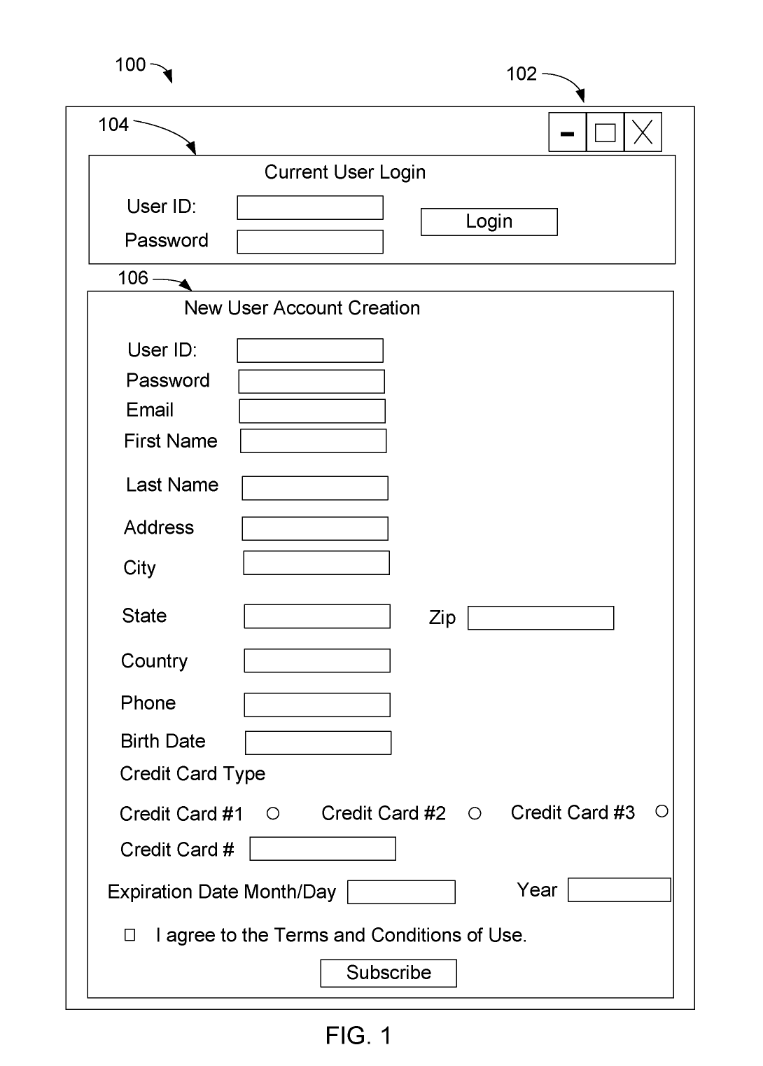

FIG. 1 illustrates an example GUI presentation for subscribing with the system or accessing the system, in accordance with an embodiment of the present invention.

A GUI presentation 100 includes a presentation control portion 102, a user login portion 104 and a personal information entry portion 106.

Presentation control portion 102 enables control of GUI presentation 100. Non-limiting examples of control performed include minimizing GUI presentation 100, maximizing GUI presentation 100, reducing GUI presentation 100 and closing GUI presentation 100.

User login portion 104 provides an existing user a way to access their account. Non-limiting examples of information entered/selected via user login portion 104 include user identification, password and login selection.

Personal information entry portion 106 enables entry of information for purposes of subscribing to system and creating an account.

Non-limiting examples of information entered/selected via personal information entry portion 106 includes user identification, password, email address, first name, last name, address, city, state, country, telephone number, birth date, credit card type, credit card number, expiration month, expiration day, expiration year, terms/conditions and subscribe selection.

System may use received birth date information for verifying a potential user is of sufficient age with respect to laws and regulations for participation.

After entry of information, a potential user may select the subscribe selection in order to communicate the entered information/selections to the system for processing.

Results of processing by the system are presented to the potential user. Non-limiting examples of information presented to the potential user following processing include account successfully created and account creation rejected. Non-limiting examples for rejecting account include insufficient age and invalid credit card.

In operation, a current user enters identification information and password information followed by selection of the login selection to gain access to system. For incorrectly entered information, user is prompted to enter correct information and for correctly entered information, user is provided access to system. Furthermore, a potential user may enter personal information and associated selections followed by selecting to subscribe in order to communication the entered information and selections to the system for processing. The system accepts or rejects the received information and communicates the acceptance or rejection to the potential user. Following a rejection, the potential user may modify entered information or selections and select submit in order to communicate information to system for processing. Following an acceptance, the potential user is considered a user and may access the created account.

FIG. 1 illustrates an example GUI presentation for subscribing/accessing system, in accordance with an embodiment of the present invention.

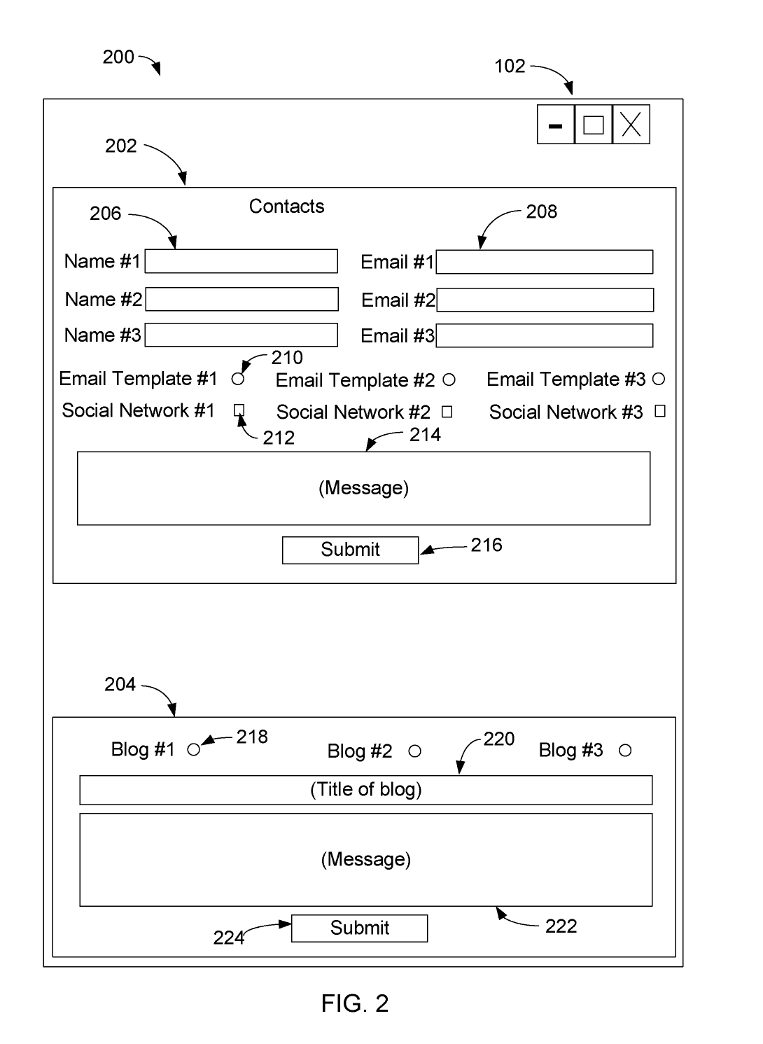

FIG. 2 illustrates an example GUI presentation for communicating with contacts, in accordance with an embodiment of the present invention.

A GUI presentation 200 includes presentation control portion 102, a contact communication portion 202 and a blog communication portion 204.

Contact communication portion 202 enables communication between a user and the user's associated contacts.

Contact communication portion 202 includes a multiplicity of name entry portions with a sampling noted as a name entry portion 206, a multiplicity of email entry portions with a sampling noted as an email entry portion 208, a multiplicity of email template selections with a sampling noted as an email template selection 210, a multiplicity of social network selections with a sampling noted as a social network selection 212, a message entry portion 214 and a submit selection 216.

User may enter the name of a contact into name entry portion 206. Furthermore, user may enter the email address of a contact into email entry portion 208. Furthermore, user may select an email template for communication with contact via email template selection 210. Furthermore, user may select a social network or social networks for communication with contact via social network selection 212. Furthermore, user may select a message to communicate with contact via message entry portion 214. Furthermore, user may select to submit entered information for processing by system via selection of submit selection 216.

In operation, user enters name or names of contact(s), email address or email addresses of respective contact(s), selects an email template, selects a social network or a multiplicity of social networks, enters a message and selects to submit entered information for processing. Information is then processed by system and communicated to user's contact or contacts.

Blog communication portion 204 includes a multiplicity of blog selections with a sampling noted as a blog selection 218, a title entry portion 220, a message entry portion 222 and a submit selection 224.

Blog communication portion 204 enables a user to communicate information via a blog or blogs.

User may enter a title associated with the information to be posted via title entry portion 220. Furthermore, user may enter information for communication to be posted via message entry portion 222. Furthermore, user may select to submit information to blog or blogs by selecting submit selection 224.

In operation, user selects blog or blogs for communication of information, selects title of information to be posted, enters information to be posted and selects submit selection to submit information for posting to blog.

FIG. 2 illustrates an example GUI presentation enabling a user to communicate to a contact or a multiplicity of contacts via email, social networks and/or blog, in accordance with an embodiment of the present invention.

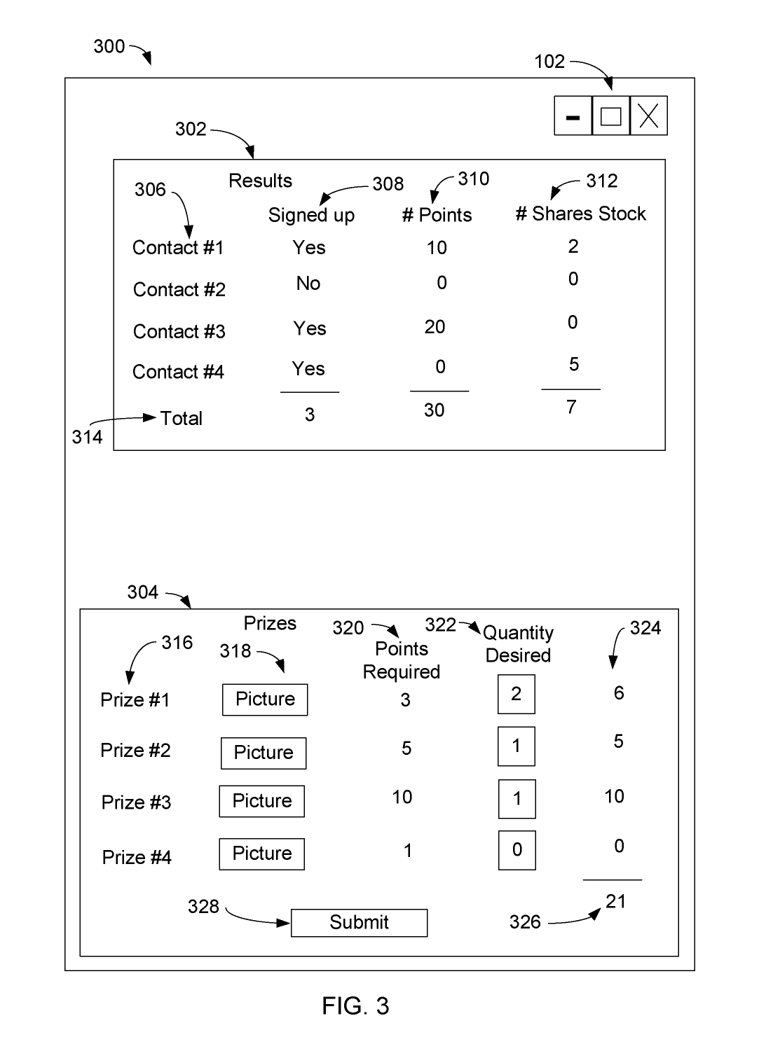

FIG. 3 illustrates an example GUI presentation for presenting results and prizes, in accordance with an embodiment of the present invention.

A GUI presentation 300 includes presentation control portion 102, a results portion 302 and a prizes portion 304.

Results portion 302 presents information associated with a user's contacts or contacts of a user's contacts.

Results portion 302 includes a contact column 306, a subscribed column 308, a points column 310, a shares column 312 and a total indication 314.

Contact column 306 lists contacts and contact of contacts associated with user.

Subscribed column 308 indicates whether contact or contacts of contacts listed in contact column 306 have subscribed with system.

Points column 310 indicates the number of points associated with contacts or contacts of contacts listed in contact column 306.

Shares column 312 indicates the number of shares associated with contacts or contacts of contacts listed in contact column 306.

Total indication 314 presents a summation of the number of contact or contacts of contacts subscribed, the total number of points accumulated for subscribed contacts or contacts of contacts and the number of shares of stock accumulated for subscribed contacts or contacts of contacts.

Prizes portion 304 presents information associated with available prizes.

Prizes portion 304 includes a prizes column 316, a picture column 318, a points needed column 320, a quantity selection column 322, a quantity selected column 324, a total quantity selected indication 326 and a submit selection 328.

Prizes column 316 lists available prizes. Picture column 318 presents a picture or image of the prize listed in prizes column 316. Points needed column 320 presents a quantity of points associated with the prize listed in prizes column 316. Quantity selection column 322 enables entry of a quantity of prizes associated with prizes column 316 for awarding to user. Points needed column 320 presents the quantity of points needed for award of the prize listed in prizes column 316. Furthermore, quantity selected column 324 may be calculated as the number of points needed as listed in points needed column 320 multiplied by the quantity selected as presented by quantity selection column 322. Total quantity selected indication 326 represents the summation of the quantities as listed in quantity selected column 324. Submit selection 328 enables presentation of information to system for processing.

In operation, a user views the information presented in results portion 302 in order to view successful subscription of contacts. Furthermore, user may select a quantity of prizes via prizes portion 304 to be awarded based upon the successful subscription of associated contacts and contacts of contacts as presented via results portion 302.

FIG. 3 illustrates an example GUI presentation communicating results information associated with contacts and available prizes, in accordance with an embodiment of the present invention.

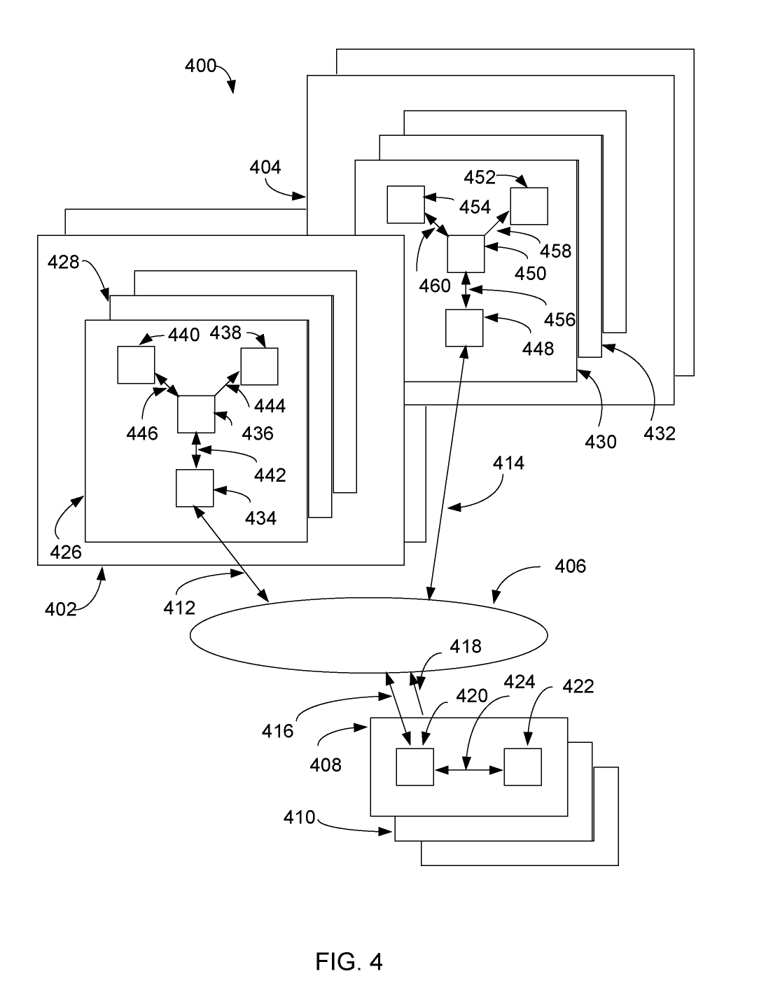

FIG. 4 illustrates a block diagram depicting a conventional client/server communication system.

A communication system 400 includes a multiplicity of networked regions with a sampling of regions denoted as a network region 402 and a network region 404, a global network 406 and a multiplicity of servers with a sampling of servers denoted as a server device 408 and a server device 410.

Network region 402 and network region 404 may operate to represent a network contained within a geographical area or region. Non-limiting examples of representations for the geographical areas for the networked regions may include postal zip codes, telephone area codes, states, counties, cities and countries. Elements within network region 402 and 404 may operate to communicate with external elements within other networked regions or within elements contained within the same network region.

In some implementations, global network 406 may operate as the Internet. It will be understood by those skilled in the art that communication system 400 may take many different forms. Non-limiting examples of forms for communication system 400 include local area networks (LANs), wide area networks (WANs), wired telephone networks, cellular telephone networks or any other network supporting data communication between respective entities via hardwired or wireless communication networks. Global network 406 may operate to transfer information between the various networked elements.

Server device 408 and server device 410 may operate to execute software instructions, store information, support database operations and communicate with other networked elements. Non-limiting examples of software and scripting languages which may be executed on server device 408 and server device 410 include C, C++, C# and Java.

Network region 402 may operate to communicate bi-directionally with global network 406 via a communication channel 412. Network region 404 may operate to communicate bi-directionally with global network 406 via a communication channel 414. Server device 408 may operate to communicate bi-directionally with global network 406 via a communication channel 416. Server device 410 may operate to communicate bi-directionally with global network 406 via a communication channel 418. Network region 402 and 404, global network 406 and server devices 408 and 410 may operate to communicate bi-directionally and also communicate bi-directionally with other networked device located within communication system 400.

Server device 408 includes a networking device 420 and a server 422. Networking device 420 may operate to communicate bi-directionally with global network 406 via communication channel 416 and with server 422 via a communication channel 424. Server 422 may operate to execute software instructions and store information.

Network region 402 includes a multiplicity of clients with a sampling denoted as a client 426 and a client 428. Client 426 includes a networking device 434, a processor 436, a GUI 438 and an interface device 440. Non-limiting examples of devices for GUI 438 include monitors, televisions, cellular telephones, smartphones and PDAs (Personal Digital Assistants). Non-limiting examples of interface device 440 include pointing device, mouse, trackball, scanner and printer. Networking device 434 may communicate bi-directionally with global network 406 via communication channel 412 and with processor 436 via a communication channel 442. GUI 438 may receive information from processor 436 via a communication channel 444 for presentation to a user for viewing. Interface device 440 may operate to send control information to processor 436 and to receive information from processor 436 via a communication channel 446. Network region 404 includes a multiplicity of clients with a sampling denoted as a client 430 and a client 432. Client 430 includes a networking device 448, a processor 450, a GUI 452 and an interface device 454. Non-limiting examples of devices for GUI 438 include monitors, televisions, cellular telephones, smartphones and PDAs (Personal Digital Assistants). Non-limiting examples of interface device 440 include pointing devices, mousse, trackballs, scanners and printers. Networking device 448 may communicate bi-directionally with global network 406 via communication channel 414 and with processor 450 via a communication channel 456. GUI 452 may receive information from processor 450 via a communication channel 458 for presentation to a user for viewing. Interface device 454 may operate to send control information to processor 450 and to receive information from processor 450 via a communication channel 460.

For example, consider the case where a user interfacing with client 426 may want to execute a networked application. A user may enter the IP (Internet Protocol) address for the networked application using interface device 440. The IP address information may be communicated to processor 436 via communication channel 446. Processor 436 may then communicate the IP address information to networking device 434 via communication channel 442. Networking device 434 may then communicate the IP address information to global network 406 via communication channel 412. Global network 406 may then communicate the IP address information to networking device 420 of server device 408 via communication channel 416. Networking device 420 may then communicate the IP address information to server 422 via communication channel 424. Server 422 may receive the IP address information and after processing the IP address information may communicate return information to networking device 420 via communication channel 424. Networking device 420 may communicate the return information to global network 406 via communication channel 416. Global network 406 may communicate the return information to networking device 434 via communication channel 412. Networking device 434 may communicate the return information to processor 436 via communication channel 442. Processor 436 may communicate the return information to GUI 438 via communication channel 444. User may then view the return information on GUI 438.

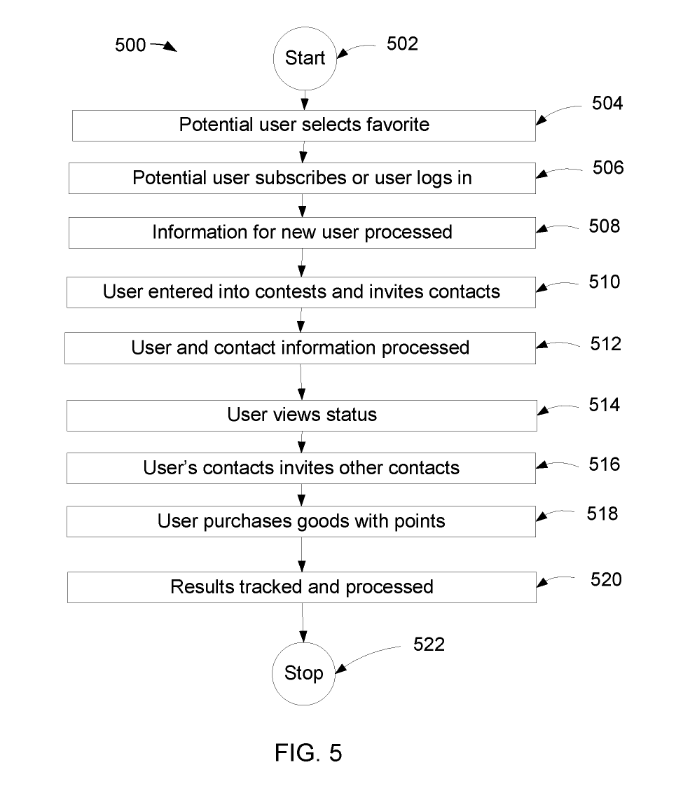

FIG. 5 illustrates an example method for operation of system for interacting with users and for processing, in accordance with an embodiment of the present invention.

A flow chart 500 initiates in a step 502.

Then in a step 504, a prospective user selects a favorite.

As a non-limiting example, a prospective user may view a movie followed by selection of the viewed movie as a favorite.

Then in a step 506, a prospective user subscribes with the system or accesses the system.

As a non-limiting example, a prospective user may be presented with GUI presentation 100 as described with reference to FIG. 1. Furthermore, GUI presentation 100 may be presented to prospective user via GUI 438 as described with reference to FIG. 4. Furthermore, a prospective user may enter personal information for creating an account. Non-limiting examples of personal information provided/selected include email, name, address, phone number, credit card details, birth date, user account identification, user account password and selection of terms and conditions of use. A user already subscribed with the system may enter user identification information and password information and select to access system.

Referring back to FIG. 5, then in a step 508 information entered by a new user in step 506 is processed by system.

As an example, personal information entered by new user may be stored in a database operated by server device 408 as described with reference to FIG. 4 for later retrieval and processing.

Referring back to FIG. 5, then in a step 510, user may be entered into contests and may invite contacts to participate.

As a non-limiting example, user may be presented with GUI presentation 200 as described with reference to FIG. 2. User may select to enter information associated with contacts. Furthermore, user may select to communicate with contacts via email, social networks or blogs. Furthermore, user may select title and message to be communicated to contacts.

Referring back to FIG. 5, then in a step 512 contact information associated with user is stored and processed.

As a non-limiting example, favorite information received from contacts associated with user may be stored and processed.

In a step 514, user may view status information.

As a non-limiting example, user may view results portion 302 associated with GUI presentation 300 as described with reference to FIG. 3. Furthermore, user may view status of contacts and points and number of shares of stock associated with subscribed contacts.

In a step 516, user's contacts may communicate with their associated contacts.

As a non-limiting example, the contacts of user may be presented with GUI presentation 200 as described with reference to FIG. 2. User's contacts may select to enter information associated with their contacts. Furthermore, user's contacts may select to communicate with their contacts via email, social networks or blogs. Furthermore, user's contacts may select title and message to be communicated to their contacts.

Referring back to FIG. 5, then in a step 518, user may purchase goods with accumulated points.

As a non-limiting example, user may view prizes portion 304 with respect to GUI presentation 300 as described with reference to FIG. 3. User may view available prizes and select to purchase prizes with accumulated points.

Then in a step 520, system may track and process information associated with users and contacts.

As a non-limiting example, system may track and store purchasing habits of users and contacts. Furthermore, system may track and store global network transitions of users and contacts. Furthermore, system may use information received from tracking users and contacts for generating promotions and promotional material.

Then in a step 522 execution of flow chart 500 terminates.

FIG. 5 illustrates an example method for operation of system for interacting with users and for tracking and processing received information, where a user creates an account, accesses account, configures account, encourages others to subscribe, views status information and receives rewards.

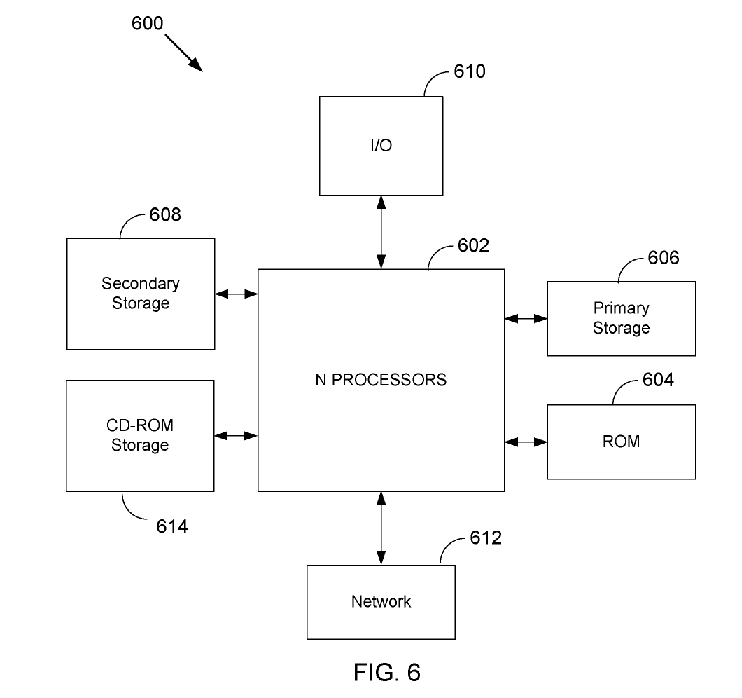

FIG. 6 illustrates a typical computer system that, when appropriately configured or designed, may serve as a computer system 600 for which the present invention may be embodied.

Computer system 600 includes a quantity of processors 602 (also referred to as central processing units, or CPUs) that may be coupled to storage devices including a primary storage 606 (typically a random access memory, or RAM), a primary storage 604 (typically a read-only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 604 acts to transfer data and instructions uni-directionally to the CPU and primary storage 606 typically may be used to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and typically may be used as a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6). In some embodiments, the methods and/or system components which may be located and/or performed remotely include, without limitation: servers and global communications network.

It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breath life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of systems for marketing/promoting products and projects according to the present invention will be apparent to those skilled in the art. The invention has been described above by way of illustration, and the specific embodiments disclosed are not intended to limit the invention to the particular forms disclosed. For example, the particular implementation of the GUIs may vary depending upon the particular type computing device used. The computing devices described in the foregoing were directed to laptop computing implementations; however, similar techniques using mobile computing implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A non-transitory computer-readable storage medium with an executable program stored thereon, wherein the program instructs a processor to perform the following steps:
obtaining from a potential user a favorite selection of viewed presentations for submission to a system server in which the selection information is processed and stored by the system server;
obtaining from the potential user registration information for submission to the system server in which the registration information is processed and stored by the system server;
receiving from the system server registration confirmation that the potential user has been accepted as a registered user and the registered user is entered into a contest;
obtaining from the registered user a message inviting potential users to view a presentation and become a registered user to participate in the contest, at least one contact name and an address for the contact name for submission to the system server in which the system server sends the message to the contact name at the address;
receiving from the server status information at least indicating contacts accepting the invitation, points awarded in the contest for the acceptances and prizes available in exchange for points; and
obtaining from the registered user a selection of at least one prize to be redeemed with the registered user's points for submission to the system server.

2. The program instructing the processor as recited in claim 1, further comprising the step of obtaining from the registered user additional contact names and addresses for the contact names for submission to the system server in which the system server sends the message to the contact names at the addresses.

3. The program instructing the processor as recited in claim 1, further comprising the step of obtaining from the registered user a selection for a template to be used in sending the message for submission to the system server in which the system server sends the message using the template.

4. The program instructing the processor as recited in claim 1, further comprising the step of obtaining from the registered user a selection for a destination to be used in sending the message for submission to the system server in which the system server sends the message to the destination.

5. The program instructing the processor as recited in claim 1, further comprising the step of receiving from the system server promotions generated by the system server from processed information received by the server from the registered user.

6. The program instructing the processor as recited in claim 1, further comprising the steps of:
obtaining from the registered user additional contact names and addresses for the contact names for submission to the system server in which the system server sends the message to the contact names at the addresses;
obtaining from the registered user a selection for a template to be used in sending the message for submission to the system server in which the system server sends the message using the template;
obtaining from the registered user a selection for a destination to be used in sending the message for submission to the system server in which the system server sends the message to the destination; and
receiving from the system server promotions generated by the system server from processed information received by the server from the registered user.

7. The program instructing the processor as recited in claim 1, in which the registered user is awarded additional points for contacts of a contact of the registered user accepting an invitation.

8. The program instructing the processor as recited in claim 1, in which the status information further indicates contacts that have failed to accept the invitation.

9. A computer-implemented system comprising:
a first processing component being configured to be operable for processing and storing a favorite selection of viewed presentations submitted by potential user;
a second processing component being configured to be operable for processing and storing registration information obtained from the potential user;
a third processing component being configured to be operable for sending confirmation of registration and entry into a contest to the potential user;
a fourth processing component being configured to be operable for processing and storing a message inviting potential users to view a presentation and become a registered user to participate in the contest, at least one contact name and an address for the contact name submitted by the registered user, said fourth processing component being further configured sending the message to the contact name at the address;
a fifth processing component being configured to be operable for generating and sending status information at least indicating contacts accepting the invitation, points awarded in the contest for the acceptances and prizes available in exchange for points to the registered user; and
a sixth processing component being configured to be operable for processing and storing a selection of at least one prize to be redeemed with points submitted by the registered.

10. The computer-implemented system as recited in claim 11, in which said fourth processing component is further configured to be operable for processing and storing additional contact names and addresses submitted by the registered user, said fourth processing component being further configured to be operable for sending the message to the contact names at the addresses.

11. The computer-implemented system as recited in claim 11, in which said fourth processing component is further configured to be operable for processing and storing a selection for a template to be used in sending the message submitted by the registered user, said fourth processing component being further configured to be operable for sending the message using the template.

12. The computer-implemented system as recited in claim 11, in which said fourth processing component is further configured to be operable for processing and storing a selection for a destination to be used in sending the message submitted by the registered user, said fourth processing component being further configured to be operable for sending the message to the destination.

13. The computer-implemented system as recited in claim 11, further comprising a seventh processing component being configured to be operable for generating promotions from processed information received from the registered user, said seventh processing unit being further configured to be operable for sending the promotions to the registered user.

14. The computer-implemented system as recited in claim 11, in which said fifth processing component is further configured to be operable for awarding additional points for contacts of a contact of the registered user accepting an invitation.

15. A non-transitory program storage device readable by a machine tangibly embodying a program of instructions executable by the machine to perform a method for promoting products and projects, comprising:
computer code for obtaining from a potential user a favorite selection of viewed presentations for submission to a system server in which the selection information is processed and stored by the system server;
computer code for obtaining from the potential user registration information for submission to the system server in which the registration information is processed and stored by the system server;
computer code for receiving from the system server registration confirmation that the potential user has been accepted as a registered user and the registered user is entered into a contest;
computer code for obtaining from the registered user a message inviting potential users to view a presentation and become a registered user to participate in the contest, at least one contact name and an address for the contact name for submission to the system server in which the system server sends the message to the contact name at the address;
computer code for receiving from the server status information at least indicating contacts accepting the invitation, points awarded in the contest for the acceptances and prizes available in exchange for points; and
computer code for obtaining from the registered user a selection of at least one prize to be redeemed with the registered user's points for submission to the system server.

16. The non-transitory program storage device as recited in claim 15, further comprising computer code for obtaining from the registered user additional contact names and addresses for the contact names for submission to the system server in which the system server sends the message to the contact names at the addresses.

17. The non-transitory program storage device as recited in claim 15, further comprising computer code for obtaining from the registered user a selection for a template to be used in sending the message for submission to the system server in which the system server sends the message using the template.

18. The non-transitory program storage device as recited in claim 15, further comprising computer code for obtaining from the registered user a selection for a destination to be used in sending the message for submission to the system server in which the system server sends the message to the destination.

19. The non-transitory program storage device as recited in claim 15, further comprising computer code for receiving from the system server promotions generated by the system server from processed information received by the server from the registered user.

20. The non-transitory program storage device as recited in claim 15, in which the registered user is awarded additional points for contacts of a contact of the registered user accepting an invitation.
